(19) United States
(12) Patent Application Publication
(10) Pub. No.: US 2024/0083148 A1
(43) Pub. Date: Mar. 14, 2024

(54) PACKAGE COMPRISING A BI-DIRECTIONALLY ORIENTED POLYETHYLENE FILM

(71) Applicant: SABIC GLOBAL TECHNOLOGIES B.V., BERGEN OP ZOOM (NL)

(72) Inventors: Franciscus Petrus Hermanus Schreurs, Beek (NL); Niclasina Siberta Johanna Alberdina Gerrits, Sittard (NL); Bart Albertus Hubertus van den Esschert, Sittard (NL); Attilio Scala, Maastricht (NL); Lucio Baccaro, Isernia (IT)

(21) Appl. No.: 17/767,592

(22) PCT Filed: Oct. 9, 2020
(86) PCT No.: PCT/EP2020/078421

§ 371 Date: Apr. 8, 2022

(30) Foreign Application Priority Data
Oct. 10, 2019 (EP) 19202382.8
Oct. 10, 2019 (EP) 19202385.1
Oct. 10, 2019 (EP) 19202387.7
Oct. 10, 2019 (EP) 19202390.1
Oct. 10, 2019 (EP) 19202396.8
Oct. 10, 2019 (EP) 19202402.4
Oct. 10, 2019 (EP) 19202410.7

(51) Int. Cl. B32B 27/08; B32B 27/32; B65D 65/40

(52) U.S. Cl. CPC B32B 27/08; B32B 27/32; B65D 65/40; B32B 2250/242; B32B 2307/31; B32B 2307/516; B32B 2307/518; B32B 2307/54; B32B 2307/542; B32B 2307/558; B32B 2307/581; B32B 2307/5825; B32B 2307/72; B32B 2307/7376; B32B 2307/75; B32B 2439/46; B32B 2439/70

(57) ABSTRACT

Package for storing frozen matter, preferably food products, comprising a laminated film, wherein the laminated film comprises at least a first layer and a second layer, wherein: the first layer is a bi-directionally oriented polyethylene film layer; and the second layer is a second polyethylene film layer; wherein the package comprises ≥90.0 wt % of polyethylene with regard to the total weight of the laminated film. Such package demonstrates a desirably high impact strength at temperatures below 0° C., such as at −25° C., and presents a mono-material solution allowing suitable further processing of the package via recycling technologies.

The present invention relates to a package comprising a bi-directionally oriented film.

In the field of packaging, there is an ongoing need for reduction of the quantity of material that is used to manufacture the package. Such reduction clearly provides benefits in that the package will have a lower weight, utilises less materials resources, and, after having ended its service life, will result in a reduced quantity of waste.

In a great variety of packaging applications, the package as a whole, or a part of a package, may be manufactured from polymer films. In particular, polyethylene materials are suitable and widely employed materials in all sorts of packaging.

In order to reduce the weight of a polyethylene film, one option is to reduce the thickness of the film. However, typically a reduction of thickness of such film leads to a deterioration of the properties of the film, such as its mechanical properties.

A means of increasing the mechanical properties of a polyethylene film of reduce thickness is to manufacture such film starting from a film having a higher thickness, and subjecting this film to an orientation process at temperatures below the melting point of the polyethylene material. Such orientation thus results in the film being stretched, as a result of which the thickness of the film is reduced.

Such orientation typically is performed via a bi-directional orientation process, wherein first a film is produced via cast film extrusion, which is then, after cooling to below the melting temperature, subjected to a stretching force to induce orientation in the machine direction, i.e. the direction in which the film is manufactured in the film extrusion process, and subsequently subjected to a stretching force in the transverse direction, i.e. to direction perpendicular to the machine direction in the plane of the film.

Such bi-directionally oriented polyethylene film may have film properties, such as mechanical properties, that are far superior to those of a polyethylene film having a similar thickness, but produced via conventional film production processes such as cast extrusion or blown film production, wherein the film is not subjected to stretching at temperatures below the melting point of the film.

In the field of packaging, there are certain properties that packages desirably comply with in order to suitably qualify for a given type of packaging application. A particular property for certain applications in this regard is the retention of mechanical properties at reduced temperatures to which a package may be subjected, such as during use in deep-freezing applications, where temperatures typically reach up to −30° C. It is required that, in order to qualify for use under such conditions, a package demonstrates at least a desirably good puncture resistance, tear resistance, and, where a seal is applied to a package such as a thermal seal, a good seal integrity at such low temperatures.

In storing frozen matter, the matter to be stored is typically provided in portions that can be individually used by the consumer. For example, for consumer products such as food products, a portion of the product is to be contained such that the consumer may obtain that portion in a simple manner, whilst ensuring that during production, storage and use of the contained portion of matter, the matter is not subjected to detrimental conditions from the outside environment to which the contained portion of matter is subjected. That is, the portion of matter is to be packed in such way that the package maintains a closed system until the removal of the matter from the package is desired.

One widely used way of packaging such matter for storage in deep-frozen conditions is in the form of containing it in sealed bags. Typically, such bags are produced out of polymer film materials.

A further aspect that contributes to the requirements for such frozen matter packaging materials relates to the recyclability of the materials that are used in the package. Given the ongoing desire to increase the fraction of package material that can be subjected to recycling processes, in order to reduce waste and consumption of raw materials, there is a desire to produce packages that are suitable to be recycled. One particular manner to contribute to this objective is by ensuring that the polymer materials that are used in packages that are produced from polymer film materials are of the same class of polymers. In recycling technologies, film materials that comprise multiple types of polymers are unsuitable for a certain number of method of recycling. The more uniform the composition of a stream of material for recycling, the more suitable for recycling such stream is.

Therefore, it is desirable to ensure that the package comprises a certain high fraction of polymer material that belongs to one and the same class of materials. Typically, it is desirable that the package comprises at least 90 wt %, or at least 95 wt % of polymer material of the same class, or even at least 97 wt %. Such package it typically referred to as a mono-material package.

So, this presents yet a further requirement on solutions for packaging of frozen food materials, in that they desirably comprise at least 90 wt % of polymer material of the same class.

A further particular property for certain applications in this regard is the provision of certain amount of stiffness of a packaging film, which allows for certain applications of packaging where the package needs to have such structural stiffness to be able to stand without external support, such as is the case in a pouch. A pouch typically contains liquid flowing contents, which may demonstrate a more or less viscous behaviour, such as certain food products, including for example soups, sauces, dairy products, oils, and fats, as well as certain detergent or healthcare products, such as liquid soaps, shampoos, dishwashing liquids, laundry detergents, fabric softeners, to name a few.

Further to the stiffness properties, the packaging film, in order to suit the above applications, needs to comply with a further number of material specifications. Particularly, the film needs to provide adequate barrier properties, in order to ensure that the contents are not subjected to detrimental influences from the environment, nor vice versa result in packed contents to leak out of the package; the film needs to provide an adequate puncture resistance as well as impact resistance, in order to ensure that during normal handling, no leakages of the packed material occur; and further, it is for certain applications desired that the film provides adequate printability, to that where markings are to be provided in print, which typically is provided for in packaging of articles for consumer use, this can be done as desirably high printing speed, at desirably high resolution and colour fastness.

Particularly, it is desired that the above specifications are met whilst providing a packaging material solution having a low requirement in terms of quantity of material used, vis-à-vis the materials of the art, since weight reduction is an ongoing trend in the packaging industry.

A further aspect that contributes to the requirements for such film material for pouches relates to the recyclability of the materials that are used in the package. Given the ongoing desire to increase the fraction of package material that can be subjected to recycling processes, in order to reduce waste and consumption of raw materials, there is a desire to produce packages that are suitable to be recycled. One particular manner to contribute to this objective is by ensuring that the polymer materials that are used in packages that are produced from polymer film materials are of the same class of polymers. In recycling technologies, film materials that comprise multiple types of polymers are unsuitable for a certain number of method of recycling. The more uniform the composition of a stream of material for recycling, the more suitable for recycling such stream is.

Therefore, it is desirable to ensure that the package comprises a certain high fraction of polymer material that belongs to one and the same class of materials. Typically, it is desirable that the package comprises at least 90 wt %, or at least 95 wt % of polymer material of the same class, or even at least 97 wt %. Such package it typically referred to as a mono-material package.

So, this presents yet a further requirement on solutions for pouches, in that they desirably comprise at least 90 wt % of polymer material of the same class.

A further application comprising bi-directionally oriented polyethylene films is in packages that are suitable for storing fresh cheese products, such as soft cheese products, particularly those that are packed with a quantity of aqueous medium. Typical examples of such soft cheese products are mozzarella-type cheese, feta-type cheese, and haloumi cheese, to name a few. A particular property for such applications is the provision of certain amount of barrier properties, that allow for the retention of the quality of the packed object, without being detrimentally affected by chemical compounds that penetrate into the package from the surrounding environment in which the package is placed during its shelf life. Also, vice versa, the package must not allow for chemical compounds that form part of the contents of the package to leak out of the package in an undesired way.

Further, the film needs to provide an adequate puncture resistance as well as impact resistance, in order to ensure that during normal handling, no leakages of the packed material occur; and further, it is for certain applications desired that the film provides adequate printability, to that where markings are to be provided in print, which typically is provided for in packaging of articles for consumer use, this can be done as desirably high printing speed, at desirably high resolution and colour fastness.

Particularly, it is desired that the above specifications are met whilst providing a packaging material solution having a low requirement in terms of quantity of material used, vis-à-vis the materials of the art, since weight reduction is an ongoing trend in the packaging industry.

A further aspect that contributes to the requirements for such film material for packages relates to the recyclability of the materials that are used in the package. Given the ongoing desire to increase the fraction of package material that can be subjected to recycling processes, in order to reduce waste and consumption of raw materials, there is a desire to produce packages that are suitable to be recycled. One particular manner to contribute to this objective is by ensuring that the polymer materials that are used in packages that are produced from polymer film materials are of the same class of polymers. In recycling technologies, film materials that comprise multiple types of polymers are unsuitable for a certain number of method of recycling. The more uniform the composition of a stream of material for recycling, the more suitable for recycling such stream is.

Therefore, it is desirable to ensure that the package comprises a certain high fraction of polymer material that belongs to one and the same class of materials. Typically, it is desirable that the package comprises at least 90 wt %, or at least 95 wt % of polymer material of the same class, or even at least 97 wt %. Such package it typically referred to as a mono-material package.

So, this presents yet a further requirement on solutions for packages for storing dairy products, in that they desirably comprise at least 90 wt % of polymer material of the same class.

A particular property for certain further applications in this regard is the resistance to punctures that may be induced to a package as a result of sharp edges or parts that are present in an object to be packed. In particular, where the packaging involves the removal of air from the package, so resulting in a vacuum package, a certain puncture pressure can be applied to the package, to which the package needs to be resistant.

A typical example of matter to be packed that may contain certain sharp edges is seafood, particularly where it relates to shellfish, lobster, crabs, and other similar products. Further, also meat products that contain bones may contain certain sharp edges. A material used for packing these products must have such properties that no perforations may occur, either during the process of packaging or during the shelf life of the product. When such perforations occur, the product will be exposed to the environment, and as a result thereof be far more prone to degradation. This needs to be avoided, and therefore the packaging material needs to be of a quality that allows for that.

Typically, to achieve this, a particularly thick plastic laminate film material is used. However, this is in contract with the above presented driver in the packaging industry to seek for reduction of material consumption and weight reduction in packaging.

Therefore, a need exists to provide a package for sharp-edged matter that combines that stringent requirements for puncture resistance with a reduction of weight of the package as compared to the current art.

A further aspect that needs to be considered is that the package needs to be sealed once the air is evacuated from the package. This sealing may for example be done by heat- sealing of the package. In order to facilitate that, the inside layer of the package should be of such nature that a strong seal can be applied, preferentially at as low sealing temperatures as possible, since use of low sealing temperatures avoids the contents of a package to unnecessarily be exposed to conditions that induce deterioration.

A further aspect that contributes to the requirements for such sharp-edged matter packaging materials relates to the recyclability of the materials that are used in the package. Given the ongoing desire to increase the fraction of package material that can be subjected to recycling processes, in order to reduce waste and consumption of raw materials, there is a desire to produce packages that are suitable to be recycled. One particular manner to contribute to this objective is by ensuring that the polymer materials that are used in packages that are produced from polymer film materials are of the same class of polymers. In recycling technologies, film materials that comprise multiple types of polymers are unsuitable for a certain number of method of recycling. The more uniform the composition of a stream of material for recycling, the more suitable for recycling such stream is.

Therefore, it is desirable to ensure that the package comprises a certain high fraction of polymer material that belongs to one and the same class of materials. Typically, it is desirable that the package comprises at least 90 wt %, or at least 95 wt %, of polymer material of the same class, or even at least 97 wt %. Such package it typically referred to as a mono-material package.

So, this presents yet a further requirement on solutions for packaging of sharp-edged matter, in that they desirably comprise at least 90 wt % of polymer material of the same class.

A further particular type of packaging where polymer films and laminates may be applied is in vacuum packaging. By means of vacuum packaging, the contents of a package are packed in such way that the quantity of air that is present inside the package is minimised, thus avoiding deterioration of the content of the package due to the reaction with air, particularly with the oxygen present in the air. This is particularly relevant to ensure a desirably long shelf life for products that are prone to such deterioration or degradation, including for example certain foodstuff products.

Such vacuum packaging typically involves placing the object that is to be packed in a container, such as a bag, and then evacuating the air from the package, followed by applying a seal to the bag that ensures that air will not enter into the package. Such seal may be applied by heat sealing.

In order to provide the desired properties to be suited for such vacuum packaging application, a polymer film or laminate must have sufficient gas barrier properties, as well as puncture resistance, and heat seal properties.

Typically, to achieve this, a particularly thick plastic laminate film material is used. However, this is in contrast with the above presented driver in the packaging industry to seek for reduction of material consumption and weight reduction in packaging. In order to facilitate that, the inside layer of the package should be of such nature that a strong seal can be applied, preferentially at as low sealing temperatures as possible, since use of low sealing temperatures avoids the contents of a package to unnecessarily be exposed to conditions that induce deterioration.

A further aspect that contributes to the requirements for such vacuum packaging materials relates to the recyclability of the materials that are used in the package. Given the ongoing desire to increase the fraction of package material that can be subjected to recycling processes, in order to reduce waste and consumption of raw materials, there is a desire to produce packages that are suitable to be recycled. One particular manner to contribute to this objective is by ensuring that the polymer materials that are used in packages that are produced from polymer film materials are of the same class of polymers. In recycling technologies, film materials that comprise multiple types of polymers are unsuitable for a certain number of method of recycling. The more uniform the composition of a stream of material for recycling, the more suitable for recycling such stream is.

Therefore, it is desirable to ensure that the package comprises a certain high fraction of polymer material that belongs to one and the same class of materials. Typically, it is desirable that the package comprises at least 90 wt %, or at least 95 wt %, of polymer material of the same class, or even at least 97 wt %. Such package it typically referred to as a mono-material package.

So, this presents yet a further requirement on solutions for vacuum packaging of, in that they desirably comprise at least 90 wt % of polymer material of the same class.

As can be understood, it is desirable that a package demonstrates a particularly high degree of such properties whilst also providing a mono-material solution. To achieve this remains the subject of developments, and has now been achieved according to the present invention by a package for storing frozen matter comprising a laminated film, wherein the laminated film comprises at least a first layer and a second layer, wherein
the first layer is a bi-directionally oriented polyethylene film layer; and
the second layer is a second polyethylene film layer;
   wherein the package comprises ≥90.0 wt %, preferably ≥95.0 wt %, preferably ≥97.0 wt %, of polyethylene with regard to the total weight of the laminated film.

Such package demonstrates a desirably high impact strength at temperatures below 0° C., such as at −25° C., and presents a mono-material solution allowing suitable further processing of the package via recycling technologies.

The second polyethylene film layer may for example be a blown extrusion film, cast extrusion film, mono-directionally oriented film, or bi-directionally oriented polyethylene film.

The first layer and the second layer may for example be bonded together via lamination, preferably wherein the bonding occurs via an adhesive layer positioned between the first layer and the second layer. Such adhesive layer may for example be in the form of a polyurethane-based adhesive, wherein the adhesive may be a solvent-based adhesive or a solvent-free adhesive.

The laminate may be formed by applying the adhesive to a surface of the first or the second film, and contacting that surface to a surface of the second film, preferably by applying a contact pressure. Such lamination may be performed in a continuous process, where the film to which the adhesive is applied is contacted with the other film, wherein the contact pressure is provided by continuously rotating nip rollers, following which the laminate is spooled onto a roll.

In an alternative embodiment, the adhesive is a melt adhesive, which is applied to a film surface in molten form. Such melt adhesive may for example be a thermoplastic material that demonstrates appropriate adhesion to both the first and the second film. For example, such melt adhesive may be a polyethylene-based material. This embodiment provides a further advantages in that the content of polyethylene material in the laminate is increased, and thereby the suitability of the materials for recycling as mono-material product. Particularly, such polyethylene-based material that may be used as melt adhesive may be a functionalised polyethylene, such as a maleic anhydride-grafted polyethylene. Such polyethylene demonstrates excellent adhesive properties, and thereby is particularly suitable for production of high-quality laminates.

The first layer may for example have a thickness of ≥15 and ≤75 μm, preferably ≥20 and ≤70 μm, even more preferably ≥30 and ≤60 μm.

The second layer may for example have a thickness of:
when the second layer is a blown extrusion film or a cast extrusion film: ≥40 and ≤300 μm, preferably ≥40 and ≤100 μm, preferably ≥50 and ≤80 μm, more preferably ≥50 and ≤70 μm; or
when the second layer is a mono-directionally oriented film or a bi-directionally oriented film: ≥15 and ≤75 μm, preferably ≥20 and ≤70 μm, even more preferably ≥30 and ≤60 μm.

In the context of the present invention, a mono-directionally oriented film is to be understood to be a film that is formed by cast extrusion, and subjected to an orientation in the machine direction of the film production line at a temperature below the melting temperature of the material of the film. A bi-directionally oriented film is to be understood to be a film that is formed by cast extrusion, and subjected to orientation in the machine direction and in the transverse direction of the film production line, at a temperature below the melting temperature of the material of the film.

In the package of the invention, the laminated film is preferably positioned such that, the first layer is positioned towards the inside of the package, when compared to second layer, and the second layer is positioned towards the outside of the package, when compared to the first layer.

A printed layer may be provided in the laminate on the surface of the first layer that is positioned towards the outside of the package.

In the context of the present invention, bi-directionally oriented films are to be understood to be films that have been produced by drawing a film both in the machine direction (MD), which is the direction in which the film is extruded from an extrusion process, and in the transverse direction (TD), which is the direction perpendicular to the MD in the plane of the film. The bi-directional drawing can be done sequentially or simultaneously. Such drawing is to be applied at a drawing temperature of below the melting point of the film.

The polymer as used in the bi-directionally oriented film has a density of ≥910 and ≤930 kg/m³. Preferably, the polymer has a density of ≥910 and ≤925 kg/m³. More preferably, the polymer has a density of ≥915 and ≤925 kg/m³. Even more preferably, the polymer has a density of ≥916 and ≤925 kg/m³, or even more preferably ≥916 and ≤922 kg/m³.

The polymer as used in the bi-directionally oriented film has a melt mass-flow rate determined at 190° C. under a load of 2.16 kg, also referred to as MFR2, of ≥0.2 and ≤5.0 g/10 min, preferably ≥0.5 or ≥0.6, and ≤5.0 g/10 min, preferably ≥0.5 or ≥0.6, and ≤4.0 g/10 min, more preferably ≥0.8 and ≤3.5 g/10 min, even more preferably ≥1.0 and ≤3.0 g/10 min, even more preferably ≥1.0 and ≤2.5 g/10 min.

The polymer as used in the bi-directionally oriented film particularly is characterised by its a-TREF fingerprint, that is, it has a particular distribution of the fractions of polymer that in a-TREF are eluted in particular defined temperature ranges in which the fractionation is performed. In particular, the polymer according to the invention has a fraction eluted in a-TREF at a temperature >94.0° C. of ≥20.0 wt %, with regard to the total weight of the polymer. More preferably, the polymer has a fraction eluted >94.0° C. of ≥25.0 wt %, even more preferably ≥30.0 wt %, yet even more preferably ≥35.0 wt %.

In the field of polyethylenes, the fraction of polymer that is eluted in a-TREF at a temperature of >94.0° C. reflects the quantity of linear polymeric material that is present in the particular polymer. In the present polymer, having a particular quantity of the material in this fraction, this indicates that a certain amount of linear polymeric material is to be present.

Further, the polymer as used in the bi-directionally oriented film has a fraction that is eluted in a-TREF at a temperature ≤30.0° C. of ≥8.0 wt %, with regard to the total weight of the polymer. The fraction that is eluted at a temperature of ≤30° C. may in the context of the present invention be calculated by subtracting the sum of the fraction eluted >94° C. and the fraction eluted >30° C. and ≤94° C. from 100%, thus the total of the fraction eluted ≤30° C., the fraction eluted >30° C. and ≤94° C. and the fraction eluted >94° C. to add up to 100.0 wt %. The fraction eluted ≤30° C. preferably is ≥9.0 wt %, more preferably ≥10.0 wt %, even more preferably ≥11.0 wt %.

Preferably, the fraction that is eluted in a-TREF at a temperature ≤30.0° C. is ≥8.0 and ≤16.0 wt %, more preferably ≥9.0 and ≤14.0 wt %, even more preferably ≥10.0 and ≤14.0 wt % with regard to the total weight of the polymer; and/or preferably, the fraction that is eluted in a-TREF at a temperature >94.0° C. is ≥20.0 and ≤50.0 wt %, more preferably ≥25.0 and ≤45.0 wt %, even more preferably ≥30.0 and ≤40.0 wt %, with regard to the total weight of the polymer; and/or preferably, the fraction that is eluted in a-TREF at a temperature >30.0° C. and ≤94.0° C. is ≥40.0 and ≤64.0 wt %, more preferably ≥45.0 and ≤60.0 wt %, even more preferably is ≥45.0 and ≤55.0 wt %.

it is preferred that the weight fraction that is eluted in a-TREF at a temperature of >30.0° C. and ≤94.0° C. is greater than the weight fraction that is eluted in a-TREF at a temperature of >94.0° C. Preferably, the fraction eluted >30.0° C. and ≤94.0° C. is at least 5.0 wt % greater than the fraction eluted >94.0° C., wherein the fractions are expressed with regard to the total weight of the polymer.

According to the invention, analytical temperature rising elution fractionation, also referred to as a-TREF, may be carried out using a Polymer Char Crystaf-TREF 300 with a solution containing 4 mg/ml of sample prepared in 1,2-dichlorobenzene stabilised with 1 g/l Topanol CA (1,1,3-tri(3-tert-butyl-4-hydroxy-6-methylphenyl)butane) and 1 g/l Irgafos 168 (tri(2,4-di-tert-butylphenyl) phosphite) at a temperature of 150° C. for 1 hour. The solution may be further stabilised for 45 minutes at 95° C. under continuous stirring at 200 rpm before analyses. For analyses, the solution was crystallised from 95° C. to 30° C. using a cooling rate of 0.1° C./min. Elution was performed with a heating rate of 1° C./min from 30° C. to 140° C. The set-up was cleaned at 150° C.

Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri(3-tert-butyl-4-hydroxy-6-methylphenyl)butane and 1 g/l tri(2,4-di-tert-butylphenyl) phosphite) at a temperature of 150° C. for 1 hour, and optionally further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

In the context of the present invention, the CCDB is determined according to formula I:

$$C C D B = \frac{{T}_{z + 2} - {T}_{n - 2}}{{T}_{n - 2}} * 100 \qquad formula 1$$

wherein
   Tₙ₋₂ is the moment calculated according to the formula II:

$${T}_{n - 2} = \frac{\sum \frac{w ( i )}{{T ( i )}^{2}}}{\sum \frac{w ( i )}{{T ( i )}^{3}}} \qquad formula 11$$

and
   T_{z+2} is the moment calculated according to the formula III:

$${T}_{z + 2} = \frac{\sum w ( i ) \cdot {T ( i )}^{4}}{\sum w ( i ) \cdot {T ( i )}^{3}} \qquad formula 111$$

wherein
   w(i) is the sampled weight fraction in wt % with regard to the total sample weight in a-TREF analysis of a sample (i) taken at temperature T(i), where T(i)>30° C., the area under the a-TREF curve being normalised to surface area=1 for T(i)>30° C.; and
T(i) is the temperature at which sample (i) is taken in a-TREF analysis, in ° C.

The polymer as used in the bi-directionally oriented film that is used in the present invention may for example be a linear low-density polyethylene. For example, the polymer may be a linear low-density polyethylene produced using a Ziegler-Natta type catalyst. The polymer as used in the present invention may for example be produced using a gas-phase polymerisation process, using a slurry-phase polymerisation process, or using a solution polymerisation process.

The polymer in the bi-directionally oriented film may for example comprise ≥80.0 wt % of moieties derived from ethylene and/or ≥5.0 wt % and <20.0 wt % of moieties derived from 1-hexene, with regard to the total weight of the polymer. Preferably, the polymer comprises ≥85.0 wt % of moieties derived from ethylene, more preferably ≥88.0 wt %. Preferably, the polymer comprises ≥80.0 wt % and ≤99.0 wt % of moieties derived from ethylene, more preferably ≥85.0 wt % and ≤95.0 wt %, even more preferably ≥88.0 wt % and ≤93.0 wt %.

The polymer in the bi-directionally oriented film may for example comprise ≥5.0 wt %, preferably ≥7.0, wt %, more preferably ≥8.0 wt %, even more preferably ≥9.0 wt %, of moieties derived from 1-hexene, with regard to the total weight of the polymer. Preferably, the polymer comprises moieties derived from ethylene and ≥5.0 wt %, preferably ≥7.0, wt %, more preferably ≥8.0 wt %, even more preferably ≥9.0 wt %, of moieties derived from 1-hexene. More preferably, the polymer comprises moieties derived from ethylene and ≥5.0 wt % and ≤20.0 wt %, preferably ≥7.0, wt % and ≤17.0 wt %, more preferably ≥8.0 wt % and ≤15.0 wt %, even more preferably ≥9.0 wt % and ≤13.0 wt %, of moieties derived from 1-hexene.

For example, the polymer in the bi-directionally oriented film may comprise ≥80.0 wt % of moieties derived from ethylene and ≥5.0 wt %, preferably ≥7.0, wt %, more preferably ≥8.0 wt %, even more preferably ≥9.0 wt %, of moieties derived from 1-hexene. Preferably, the polymer comprises ≥80.0 wt % of moieties derived from ethylene and ≥5.0 wt % and ≤20.0 wt %, preferably ≥7.0, wt % and ≤17.0 wt %, more preferably ≥8.0 wt % and ≤15.0 wt %, even more preferably ≥9.0 wt % and ≤13.0 wt %, of moieties derived from 1-hexene.

In a certain embodiment, the polymer as used in the bi-directionally oriented film consists of moieties derived from ethylene and moieties derived from 1-hexene. For example, the polymer may consist of moieties derived from ethylene and ≥5.0 wt %, preferably ≥7.0, wt %, more preferably ≥8.0 wt %, even more preferably ≥9.0 wt %, of moieties derived from 1-hexene. Preferably, the polymer consists of moieties derived from ethylene and ≥5.0 wt % and ≤20.0 wt %, preferably ≥7.0, wt % and ≤17.0 wt %, more preferably ≥8.0 wt % and ≤15.0 wt %, even more preferably ≥9.0 wt % and ≤13.0 wt %, of moieties derived from 1-hexene.

The quantity of 1-hexene derived moieties in the polyethylene may be measured by ¹³C NMR on a Bruker Avance 500 spectrometer equipped with a cryogenically cooled probe head operating at 125° C., whereby the samples are dissolved at 130° C. in C₂D₂Cl₄ containing DBPC as stabiliser.

It is in certain embodiments of the present invention preferred that the polymer has a particular degree of long-chain branching. Long-chain branching, in the context of the present invention, is to be understood to reflect the presence of certain polymeric side chains that do not originate from incorporation of comonomers, but may for example be caused by reaction of polymeric chains comprising unsaturations with a further growing chain at a catalytic site. In certain embodiments, a certain presence of such long-chain branching is desirable. An indicator for the presence of long-chain branching, in the context of the present invention, may for example be the storage modulus G′ at certain loss modulus G″. A certain high storage modulus at defined loss modulus indicates the presence of a certain quantity of long-chain branching in the polymer. Particularly preferred indicators for the presence of a certain degree of long-chain branching are the storage modulus at loss modulus of 10.0 kPa, and the storage modulus at loss modulus of 1.0 kPa. The storage modulus and the loss modulus may for example be determined in accordance with ISO 6721-10 (2015).

For example, the polymer in the bi-directionally oriented film may have a storage modulus determined at loss modulus of 10.0 kPa of >2.0 kPa, preferably >2.2 kPa, more preferably >2.5 kPa. For example, the polymer may have a storage modulus determined at loss modulus of 1.0 kPa of >50 Pa, preferably >75 Pa, more preferably >100 Pa. For example, the polymer may have a storage modulus determined at loss modulus of 1.0 kPa of >50 Pa, preferably >75 Pa, more preferably >100 Pa, and <150 Pa. For example, the storage modulus at loss modulus of 10.0 kPa may be >2.0 kPa and the storage modulus at loss modulus of 1.0 kPa may be >50 Pa, preferably the storage modulus at loss modulus of 10.0 kPa is >2.5 kPa and the storage modulus at loss modulus of 1.0 kPa is >50 and <150 Pa. The storage modulus and the loss modulus may be determined in accordance with ISO 6721-10 (2015) at a temperature of 190° C.

The polymer in the bi-directionally oriented film may for example comprise <250, preferably <200, or >100 and <250, unsaturations per 1000000 chain carbon atoms, wherein the unsaturations are determined as the sum of the vinyl unsaturations, vinylene unsaturations, vinylidene unsaturations, and triakyl unsaturations, determined via ¹H NMR. The number of unsaturations may be measured by ¹H NMR on a Bruker Avance 500 spectrometer equipped with a cryogenically cooled probe head operating at 125° C., whereby the samples are dissolved at 130° C. in C₂D₂Cl₄ containing DBPC as stabiliser.

The polymer in the bi-directionally oriented film may for example have an M_{w}/Mₙ ratio of >4.0, preferably >4.0 and <10.0, more preferably >5.0 and <8.0. For example, the polymer may have an M_{z}/Mₙ ratio of >15.0, preferably >15.0 and <40.0, preferably >20.0 and <30.0, wherein Mₙ is the number average molecular weight, M_{w} is the weight average molecular weight, and M_{z} is the z-average molecular weight, as determined in accordance with ASTM D6474 (2012). For example, the polymer may for example have an M_{w}/Mₙ ratio of >4.0, preferably >4.0 and <10.0 and an M_{z}/Mₙ ratio of >15.0, preferably >15.0 and <40.0.

It is preferred that for the polymer as used in the bi-directionally oriented film, in the range of log(M_{w}) between 4.0 and 5.5, the slope of the curve of the number of CH₃ branches per 1000 C atoms versus the log(M_{w}) is negative, wherein the number of CH₃ branches is determined via SEC-DV with and IR5 infrared detector, in accordance with ASTM D6474 (2012).

The polymer in the bi-directionally oriented film may have an M_{w} of for example >75 kg/mol, preferably >100 kg/mol, such as >75 and <200 kg/mol, preferably >100 and <150 kg/mol. The polymer may have an Mₙ of for example >15 kg/mol, preferably >20 kg/mol, such as for example >15 and <40 kg/mol, preferably >20 and <30 kg/mol. The polymer may have an M_{z} of >300 kg/mol, preferably >400 kg/mol, such as >300 and <700 kg/mol, preferably >400 and <650 kg/mol. Such characteristics of M_{w}, M_{z} and/or Mₙ may contribute to the improved stretchability of the film produced using the polymer of the invention.

The bi-directionally oriented film may for example comprise a polymer having moieties derived from ethylene and moieties derived from 1-hexene, wherein the polymer has:
(a) a density of ≥910 and ≤930 kg/m³, preferably ≥916 and ≤925 kg/m³, as determined in accordance with ASTM D792 (2008);
(b) a melt mass-flow rate of ≥0.2, preferably ≥0.5 or ≥0.6, and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature ≤30.0° C. of ≥8.0 wt %, preferably ≥11.0 wt %, with regard to the total weight of the polymer; and
(d) a fraction eluted in a-TREF at a temperature >94.0° C. of ≥20.0 wt %, with regard to the total weight of the polymer; and preferably
(e) a fraction eluted in a-TREF at a temperature >30.0° C. and ≤94.0° C. of ≥40.0 and ≤64.0 wt %, with regard to the total weight of the polymer.

In a certain embodiment, the invention also relates to a package comprising a bi-directionally oriented polyethylene film, wherein the bi-directionally oriented film comprises a polymer having moieties derived from ethylene and moieties derived from 1-hexene, wherein the polymer has:
(a) a density of ≥916 and ≤925 kg/m³ as determined in accordance with ASTM D792 (2008);
(b) a melt mass-flow rate of ≥0.6 and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature ≤30.0° C. of ≥11.0 wt %, with regard to the total weight of the polymer; and
(d) a fraction eluted in a-TREF at a temperature >94.0° C. of ≥20.0 wt %, with regard to the total weight of the polymer; and
(e) a fraction eluted in a-TREF at a temperature >30.0° C. and ≤94.0° C. of ≥40.0 and ≤64.0 wt %, with regard to the total weight of the polymer.

The package may for example comprise a bi-directionally oriented film that is oriented in the machine direction to a degree of between 3 and 10, and/or the film is oriented in the transverse direction to a degree of between 5 and 15, wherein the degree of orientation is the ratio between the dimension of the film in the particular direction subsequent to the orientation and the dimension prior to the orientation.

In certain of its embodiments, the invention also relates to a process for the production of package comprising a bi-directionally oriented film.

For example, the invention also relates in a certain embodiment to a process for the production of a package comprising a bi-directionally oriented film comprising a polymer having moieties derived from ethylene and moieties derived from 1-hexene, wherein the polymer has:
(a) a density of ≥916 and ≤925 kg/m³ as determined in accordance with ASTM D792 (2008);
(b) a melt mass-flow rate of ≥0.6 and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature ≤30.0° C. of ≥11.0 wt %, with regard to the total weight of the polymer; and
(d) a fraction eluted in a-TREF at a temperature >94.0° C. of ≥20.0 wt %, with regard to the total weight of the polymer; and
(e) a fraction eluted in a-TREF at a temperature >30.0° C. and ≤94.0° C. of ≥40.0 and ≤64.0 wt %, with regard to the total weight of the polymer.

The film may for example have an orientation in the machine direction of at least 4.0. In the context of the present invention, orientation may also be referred to as stretch. Orientation in the machine direction is to be understood to be the ratio of a the length in the machine direction of a certain quantity of material after having been subjected to a stretching force in the machine direction to the length that that very same quantity of material had prior to having been subjected to that stretching force in the machine direction.

The film may for example have an orientation in the transverse direction of at least 8. Orientation or stretch in the transverse direction is to be understood to be the ratio of the width of the film after having been subjected to a stretching force in the transverse direction to the width of the film prior to having been subjected to that stretching force in the transverse direction.

Stretching in the transverse direction may for example be achieved by clamping the film in clamps positioned on either side of the film at certain distance intervals, applying a certain heat to the film to ensure the film is at a certain temperature, and applying an amount of force onto the clamps outwards from the plane of the film in the transverse direction. Such stretching may for example be done in a continuous operation.

The bi-directionally oriented film may for example comprise >80.0 wt % of the polymer, preferably >85.0 wt %, preferably >90.0 wt %, more preferably >95.0 wt %, for example >80.0 and <98.0 wt %, or >90.0 and <98.0 wt %, with regard to the total weight of the bi-directionally oriented film.

In the package according to the invention, a sealing layer may in certain embodiments be present on the surface of the first layer that is positioned towards the inside of the package. For example, the package may be a heat-sealed bag.

The sealing layer may for example comprise a first polyethylene and optionally a second polyethylene, wherein the first polyethylene has:
a fraction of material that is eluted in analytical temperature rising elution fractionation (a-TREF) at a temperature >94.0° C. of ≤5.0 wt %, preferably ≤1.0 wt %, with regard to the total weight of the first polyethylene; and/or
a shear storage modulus G′ determined at a shear loss modulus G″=5000 Pa of >700 Pa, G′ and G″ being determined in accordance with ISO 6721-10 (2015) at 190° C.; and/or
a chemical composition distribution broadness (CCDB) of ≥5.0, preferably ≥10.0, preferably ≥15.0, preferably ≥20.0, preferably ≥5.0 and ≤30.0.

The sealing layer may for example comprise ≥15.0 wt %, ≥25.0 wt %, ≥50.0 wt %, ≥75.0 wt %, or ≥85.0 wt %, of the first polyethylene, with regard to the total weight of the sealing layer. The sealing layer may for example comprise ≥15.0 and ≤50.0 wt % of the first polyethylene, with regard to the total weight of the sealing layer. The sealing layer may for example comprise ≥15.0 and ≤50.0 wt % of the first polyethylene, with regard to the total weight of the sealing layer, and a fraction of the second polyethylene. The sealing layer may in certain embodiments contain the first polyethylene as the sole polyethylene material. For example, the sealing layer may comprise ≥30.0 and ≤99.0 wt %, or ≥30.0 and ≤97.0 wt %, of the first polyethylene.

The first polyethylene may for example comprise ≥80.0 wt % of moieties derived from ethylene and/or ≥5.0 wt % and <20.0 wt % of moieties derived from 1-octene, with regard to the total weight of the first polyethylene.

The second polyethylene may for example be a polymer having moieties derived from ethylene and moieties derived from 1-hexene, wherein the polymer has:
(a) a density of ≥910 and ≤930 kg/m³, preferably ≥916 and ≤925 kg/m³, as determined in accordance with ASTM D792 (2008);
(b) a melt mass-flow rate of ≥0.2, preferably ≥0.5 or ≥0.6, and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature ≤30.0° C. of ≥8.0 wt %, preferably ≥11.0 wt %, with regard to the total weight of the polymer; and
(d) a fraction eluted in a-TREF at a temperature >94.0° C. of ≥20.0 wt %, with regard to the total weight of the polymer; and preferably
(e) a fraction eluted in a-TREF at a temperature >30.0° C. and ≤94.0° C. of ≥40.0 and ≤64.0 wt %, with regard to the total weight of the polymer.

It is preferred that the second polyethylene in the sealing layer is equal to the polymer in the bi-directionally oriented film.

The invention also in an certain embodiment relate to the use of a bi-directionally oriented film comprising a polymer having moieties derived from ethylene and moieties derived from 1-hexene, wherein the polymer has:
(a) a density of ≥910 and ≤930 kg/m³, preferably ≥916 and ≤925 kg/m³, as determined in accordance with ASTM D792 (2008);
(b) a melt mass-flow rate of ≥0.2, preferably ≥0.5 or ≥0.6, and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature ≤30.0° C. of ≥8.0 wt %, preferably ≥11.0 wt %, with regard to the total weight of the polymer; and
(d) a fraction eluted in a-TREF at a temperature >94.0° C. of ≥20.0 wt %, with regard to the total weight of the polymer; and preferably
(e) a fraction eluted in a-TREF at a temperature >30.0° C. and ≤94.0° C. of ≥40.0 and ≤64.0 wt %, with regard to the total weight of the polymer;
for improvement of the cold impact strength at −25° C. of a package.

The frozen matter that is to be stored using the package of the present invention may for example be food products such as frozen fruit and vegetables, meat and fish products, dairy products, pre-baked bread and pastry, or processed potato products. For example, such packages may contain an end-consumer sized quantity of the food product, such as between 0.5 l and 5.0 l in volume of the food product, or between 0.5 l and 2.0 l.

### EXAMPLES

### Production of Bi-Directionally Oriented Polyethylene Films (BOPE Films)

A multi-layer A-B-C polyethylene film was produced via cast extrusion using twin-screw extruders wherein the core layer B was extruded at 60 kg/h and each of layer A and C via separate extruders at 6.0 kg/h each, resulting in a 3-layer structure comprising 7 wt % of layer A, 86 wt % of layer B, and 7 wt % of layer C. Extrusion was performed at 260° C. The cast film was extruded via a die with a die gap of 3.0 mm, at a speed of 9 m/min.

Upon extrusion, the film was cooled via a water bath. The film was oriented in machine direction via multiple orientation rolls having a temperature of between 66 and 96° C., to a degree of stretching of 12 in the machine direction. Subsequently the film was subjected to stretching in the transverse direction at temperatures from 146° C. decreasing to 110° C., to obtain a bi-directionally oriented film (film 1) having a thickness of 19 μm. The film was subject to corona treatment at 25 W.min/m². Similarly, at increased throughput, a film having a thickness of 40 μm was produced (film 4).

Formulation of BOPE films:
Layer A: 72 wt % SABIC BX202, 3 wt % Constab AB06001LD, 25 wt % SABIC COHERE 8112
Layer B: 100 wt % SABIC BX202
Layer C: 97 wt % SABIC BX202, 3 wt % Constab AB06001LD

### Production of Bi-Directionally Oriented Polypropylene Films (BOPP Films)

A multi-layer A-B-C polypropylene film was produced via cast extrusion using twin-screw extruders wherein the core layer B was extruded at 52 kg/h and each of layer A and C via separate extruders at 6.0 kg/h each, resulting in a 3-layer structure comprising 7 wt % of layer A, 86 wt % of layer B, and 7 wt % of layer C. Extrusion was performed at 260° C. The cast film was extruded via a die with a die gap of 3.0 mm, at a speed of 9 m/min.

Upon extrusion, the film was cooled via a water bath. The film was oriented in machine direction via multiple orientation rolls having a temperature of between 80 and 106° C., to a degree of stretching of 12 in the machine direction. Subsequently the film was subjected to stretching in the transverse direction at temperatures from 190° C. decreasing to 160° C., to obtain a bi-directionally oriented film having a thickness of 25 μm. The film was subject to corona treatment at 24 W.min/m².

Formulation of BOPP Film 2:
Layer A: 98 wt % Adsyl 5C30F, 2 wt % Schulman AB PP 05 SC
Layer B: 100 wt % SABIC 521P
Layer C: 98 wt % Adsyl 5C30F, 2 wt % Schulman AB PP 05 SC

### Production of Blown Film

A monolayer blown film (Film 3) was produced using SABIC BX202 using a Kuhne blown film extruder, operated at 96 RPM and fed with 24.8 kg/h of the polyethylene, at an extruder temperature of 200° C. The pressure before the filter was 113 bar, after the filter 74 bar. The film extrusion equipment was provided with a 120 mm die having a die gap of 2.3 mm. the line was operated with a freeze line height of 30 cm, and a blow-up ration of 2.5, with a winder speed of 18 m/min. the obtained film had a thickness of 25 μm.

A further blown film (film 5) was produced as 3-layer film, having a thickness of 60 μm, having an A/B/C construction. The blown film extrusion line was fed by 3 extruders, for each layer, wherein layer A was of formulation 75 wt % SABIC SUPEER 7118NE and 25 wt % SABIC LDPE 2501N0; layer B of 75 wt % SABIC HDPE F04660 and 25 wt % SABIC LDPE 2501N0; and layer C of 25 wt % SABIC COHERE S100 and 75 wt % SABIC LDPE 2501N0. The film 5 consisted of 30 wt % layer A (17 μm); 60 wt % layer B (35 μm); 10 wt % layer C (8 μm). The combined output of the extruders was 200 kg/h. Winder speed was 23 m/min; further conditions as for film 3.

### Film Lamination

Roll to roll lamination was performed using a Drytex drying tunnel lamination unit at a lamination speed of 5 m/min, with a hot air drying temperature of 50° C., using Henkel Liofol 3640 adhesive in a quantity of 94 ml/m².

Of the films 1-3 as prepared above, the below properties were determined:

| | Film 1 | Film 2 | Film 3 |
|---|---|---|---|
| Example | BOPE | BOPP | Blown PE |
| Thickness (μm) | 19 | 25 | 25 |
| Impact strength 23° C. (g/25 μm) | 508 | 954 | 87 |
| Tensile strength at break MD at −25° C. (MPa) | 59 | 154 | 86 |
| Tensile strength at break MD at 23° C. (MPa) | 39 | 121 | 62 |
| Elongation at break MD at −25° C. (%) | 240 | 161 | 603 |
| Elongation at break MD at 23° C. (%) | 288 | 191 | 556 |
| Tear Resistance MD (g/25 μm) | 22 | 8 | 291 |
| Tear Resistance TD (g/25 μm) | 5 | 4 | 704 |
| Puncture resistance at 23° C. (N/25 μm) | 118 | 247 | 72 |
| Puncture resistance at −25° C. (N/25 μm) | 109 | 217 | 43 |
| Seal strength of seal produced at 80° C. (N/15 mm) | 0.07 | 0.07 | 0.08 |
| Seal strength of seal produced at 90° C. (N/15 mm) | 0.57 | 0.17 | 0.41 |
| Seal strength of seal produced at 100° C. (N/15 mm) | 5.8 | 0.51 | 4.9 |
| Seal strength of seal produced at 110° C. (N/15 mm) | 7.0 | 3.5 | 5.8 |
| Seal strength of seal produced at 120° C. (N/15 mm) | 10.5 | 3.2 | 6.0 |

### Wherein:

The impact strength was determined in accordance with ASTM D1709A (2016);
The tensile strength at break MD is determined on the film in the machine direction, in accordance with ASTM D882 (2018), using an initial sample length of 50 mm and a testing speed of 500 mm/min;
The elongation at break MD is determined on the film in the machine direction, in accordance with ASTM D882 (2018), determined at room temperature using an initial sample length of 50 mm and a testing speed of 500 mm/min;
Tear resistance is measured in the machine direction (MD) and the transverse direction (TD) in accordance with the method of ASTM D1922 (2015).
Puncture resistance is the maximum force as determined in accordance with ASTM D5748-95 (2012), expressed in N;

The heat seal strength was determined in accordance with ASTM F88, using method A, on specimens of 15 mm width. Fin-seals were prepared according ASTM F2029 at different temperatures. Two samples of the same film were compressed together, with layer C of the first film sample contacting layer C of the second film sample. Seals were produced by applying a force of 3.0 bar for 1.0 sec, wherein the films were protected with a 25 μm cellophane sheet. The press used for preparing the seal was heated to various temperatures to identify the strength of the seal when produced at different temperatures. The seal strength was tested using a tensile testing machine with a testing speed of 200 mm/min, and a grip distance of 10 mm. The maximum load was recorded as the seal strength.

Production of Laminates

The following laminates were produced as per the method above:

| Laminate | L1 | L2 | L3 |
|---|---|---|---|
| BO film | Film 1 | Film 5 | BOPET |
| Blown film | Film 5 | Film 5 | Film 5 |
| Thickness (μm) | 80 | 100 | 72 |
| Puncture Energy to break (J) | 2.7 | 5.7 | 1.8 |
| Puncture Energy to break (J/μm) | 0.034 | 0.057 | 0.025 |

Puncture energy to break is as determined in accordance with ASTM D5748-95 (2012), expressed in J, or, when corrected for the film thickness, in J/μm.

1. A package comprising a laminated film, wherein the laminated film comprises at least a first layer and a second layer, wherein:
the first layer is a bi-directionally oriented polyethylene film layer; and
the second layer is a second polyethylene film layer;
wherein the package comprises ≥90.0 wt % of polyethylene with regard to the total weight of the laminated film.

2. The package according to claim 1, wherein the package is a package for storing frozen matter; a package for storing food products; a package for storing liquid-flowing food products, liquid detergents, or liquid healthcare products; or a package for storing sharp-edged matter.

3. The package according to claim 1, wherein the second polyethylene film layer is a blown extrusion film, cast extrusion film, mono-directionally oriented film, or bi-directionally oriented polyethylene film.

4. The package according to claim 1, wherein the first layer and the second layer are bonded together via lamination.

5. The package according to claim 1, wherein the first layer has a thickness of ≥15 and ≤75 μm.

6. The package according to claim 1, wherein the second layer has a thickness of:
when the second layer is a blown extrusion film or a cast extrusion film: ≥40 and ≤100 μm; or
when the second layer is a mono-directionally oriented film or a bi-directionally oriented film: ≥15 and ≤75 μm.

7. The package according to claim 1, wherein the laminated film is positioned such that, the first layer is positioned towards an inside of the package, when compared to second layer, and the second layer is positioned towards an outside of the package, when compared to the first layer.

8. The package according to claim 1, wherein the bi-directionally oriented film comprises a polymer having moieties derived from ethylene and moieties derived from 1-hexene, wherein the polymer has:
(a) a density of ≥910 and ≤930 kg/m³, as determined in accordance with ASTM D792 (2008);
(b) a melt mass-flow rate of ≥0.2, as determined in accordance with ASTM D1238 (2013) at a temperature of 190° C. under a load of 2.16 kg;
(c) a fraction that is eluted in analytical temperature rising elution fractionation (a-TREF) at a temperature ≤30.0° C. of ≥8.0 wt %, with regard to the total weight of the polymer; and
(d) a fraction eluted in a-TREF at a temperature >94.0° C. of ≥20.0 wt %, with regard to the total weight of the polymer.

9. The package according to claim 8, wherein the polymer comprises ≥80.0 wt % of moieties derived from ethylene and/or ≥5.0 wt % and <20.0 wt % of moieties derived from 1-hexene, with regard to the total weight of the polymer.

10. The package according to claim 8, wherein the polymer has an M_{w}/Mₙ ratio of >4.0, and/or wherein the polymer has an M_{z}/Mₙ ratio of >15.0, wherein Mₙ is the number average molecular weight, M_{w} is the weight average molecular weight, and M_{z} is the z-average molecular weight, as determined in accordance with ASTM D6474 (2012).

11. The package according to claim 1, wherein a sealing layer is present on a surface of the first layer that is positioned towards an inside of the package.

12. The package according to claim 1, wherein the package is a heat-sealed bag, a pouch or a vacuum package.

13. The package according to claim 11, wherein the sealing layer comprises a first polyethylene and optionally a second polyethylene, wherein the first polyethylene has:
a fraction of material that is eluted in analytical temperature rising elution fractionation (a-TREF) at a temperature >94.0° C. of ≤5.0 wt %, with regard to the total weight of the first polyethylene; and/or
a shear storage modulus G′ determined at a shear loss modulus G″=5000 Pa of >700 Pa, G′ and G″ being determined in accordance with ISO 6721-10 (2015) at 190° C.; and/or
a chemical composition distribution broadness (CCDB) of ≥5.0.

14. The package according to claim 13, wherein:
the sealing layer comprises ≥15.0 and ≤50.0 wt % of the first polyethylene, with regard to the total weight of the sealing layer; and/or
the first polyethylene comprises ≥80.0 wt % of moieties derived from ethylene and/or ≥5.0 wt % and <20.0 wt % of moieties derived from 1-octene, with regard to the total weight of the first polyethylene.

15. The package according to claim 12, wherein the second polyethylene is a polymer having moieties derived from ethylene and moieties derived from 1-hexene, wherein the polymer has:
(a) a density of ≥910 and ≤930 kg/m³, as determined in accordance with ASTM D792 (2008);
(b) a melt mass-flow rate of ≥0.2, as determined in accordance with ASTM D1238 (2013) at a temperature of 190° C. under a load of 2.16 kg;
(c) a fraction that is eluted in analytical temperature rising elution fractionation (a-TREF) at a temperature ≤30.0° C. of ≥8.0 wt %, with regard to the total weight of the polymer; and
(d) a fraction eluted in a-TREF at a temperature >94.0° C. of ≥20.0 wt %, with regard to the total weight of the polymer.
preferably wherein the second polyethylene in the sealing layer is equal to the polymer in the bi-directionally oriented film.

16. The package according to claim 15, wherein the second polyethylene in the sealing layer is equal to the polymer in the bi-directionally oriented film.

17. The package according to claim 1, wherein the first layer and the second layer are bonded together via an adhesive layer positioned between the first layer and the second layer.

18. The package according to claim 1, wherein the polymer has a fraction eluted in a-TREF at a temperature >30.0° C. and ≤94.0° C. of ≥40.0 and ≤64.0 wt %, with regard to the total weight of the polymer.
